(19) United States
(12) Patent Application Publication
(10) Pub. No.: US 2002/0141319 A1
(43) Pub. Date: Oct. 3, 2002

(54) Optical pickup device capable of emitting small-diameter laser beam used with enhanced efficiency

(75) Inventors: Yoshiyuki Matsumura, Anpachi-gun (JP); Masato Yamada, Inuyama-shi (JP); Yoichi Tsuchiya, Hashima-shi (JP)

Correspondence Address: ARMSTRONG,WESTERMAN & HATTORI, LLP, 1725 K STREET, NW., SUITE 1000, WASHINGTON, DC, 20006, US

(73) Assignee: Sanyo Electric Co. Ltd., Moriguchi-shi (JP)

(21) Appl. No.: 10/101,623

(22) Filed: Mar. 21, 2002

(30) Foreign Application Priority Data
Mar. 28, 2001 (JP) 2001-092815 (P)

(51) Int. Cl. G11B 7/135

(52) U.S. Cl. 369/112.05

(57) ABSTRACT

A phase corrector unit has first to fifth regions on its plane on which a laser beam is incident. The second and fourth regions are formed of protrusions each having height d of approximately 730 nm, and the thickness of a quartz glass where the protrusions are formed is 0.5 mm. The second region is larger in the width than the fourth region. The width of the third region is larger than the width (diameter) of the fifth region, and the width in the direction of the side of the first region is larger than the width of the third region. An optical pickup device includes the phase corrector unit placed between a semiconductor laser and an objective lens. Thus, the optical pickup device emits a small-diameter laser beam without seriously deteriorating the efficiency of use of the laser beam.

### BACKGROUND OF THE INVENTION

1. Field of the Invention

The present invention relates to optical pickup devices irradiating an optical disk with a laser beam of a considerably small diameter by means of optical super resolution without serious deterioration of efficiency in use of the laser beam.

2. Description of the Background Art

Optical disks like DVD (Digital Video Disk) for example having a greater recording capacity than that of CD (Compact Disk) have been turned into practical use as high-density recording media and would become widespread in the future.

Moreover, it is expected that an optical disk having a higher recording density than that of DVD will be developed. Such an increased density of optical disks is achieved by reduction of the pit size formed on an optical disk like DVD.

Attention is now focused on magnetooptical recording media as rewritable and reliable recording media having a large storage capacity, and some magnetooptical recording media have actually been employed as computer memories for example. Standardization of a magnetooptical recording medium having a recording capacity of 6.0 Gbytes has recently been achieved as AS-MO (Advanced Storage Magneto Optical Disk) standard and practical use of this medium is in progress.

For reproduction of such a high-density optical disk, a laser beam is required that has a beam diameter which is small enough to avoid a plurality of pits or magnetic domains from being enclosed within a beam spot. The spot size of a laser beam is proportional to the wavelength of the laser beam and inversely proportional to the numerical aperture (NA) of an objective lens. Thus, a laser beam having a small spot size has been produced by shortening the wavelength of a laser beam and increasing the numerical aperture of the objective lens.

Optical super resolution is known as a method of reducing the spot size of a laser beam. According to optical super resolution, a central portion of a laser beam is blocked out to irradiate an optical disk with the laser beam formed of main and side beams. Thus, the main beam can have a smaller diameter than the beam diameter of the laser beam with its central portion not being blocked out.

This conventional optical super resolution for reducing the beam diameter has a problem that the efficiency in use of a laser beam deteriorates since the central portion of the laser beam is blocked out. Side beams resultant from blocking of the central portion of the laser beam have a high intensity, and then another problem arises that the side beams could cause a signal to be recorded on or reproduced from an optical disk.

### SUMMARY OF THE INVENTION

One object of the present invention is to provide an optical pickup device capable of emitting a small-diameter laser beam without seriously deteriorating efficiency in use of the laser beam.

According to the present invention, an optical pickup device includes a laser source generating a laser beam, a phase corrector unit having a plurality of regions arranged in the radial direction of the laser beam for providing a phase difference corresponding to the half-wavelength of the laser beam to the laser beam incident on two adjacent regions of those plurality of regions, and an objective lens concentrating the laser beam from the phase corrector unit onto an optical disk. Those plurality of regions have respective lengths in the radial direction that are different from each other. “Phase difference corresponding to the half-wavelength of the laser beam” according to the present invention includes a phase difference equal to an odd multiple of the half-wavelength of the laser beam.

Preferably, one of the two adjacent regions has a first optical path length in the optical axis direction of the laser beam, the other of the two adjacent regions has a second optical path length in the optical axis direction of the laser beam, and a difference between the first optical path length and the second optical path length corresponds to the half-wavelength of the laser beam.

Preferably, the phase corrector unit is formed of a first material and second materials formed on a main surface of the first material with a predetermined distance therebetween. Air adjoining the second materials in the radial direction of the laser beam has an optical path length in the optical axis direction of the laser beam and the second materials have an optical path length in the optical axis direction of the laser beam. A difference between respective optical path lengths corresponds to the half-wavelength of the laser beam.

Preferably, the phase corrector unit is formed of a material having rectangular notches formed at a main surface with a predetermined distance therebetween. The material has a part which adjoins the rectangular notches in the radial direction of the laser beam and the part has an optical path length in the optical axis direction of the laser beam and, the rectangular notches have an optical path length in the optical axis direction of the laser beam. A difference between respective optical path lengths corresponds to the half-wavelength of the laser beam.

Preferably, the phase corrector unit is formed of a material having rectangular notches with a predetermined distance therebetween, and the notches are formed on a side on which the laser beam is incident as well as on a side from which the laser beam is emitted. The material has a part which adjoins the rectangular notches in the radial direction of the laser beam and the part has an optical path length in the optical axis direction of the laser beam. The rectangular notches have an optical path length in the optical axis direction of the laser beam. A difference between respective optical path lengths corresponds to the half-wavelength of the laser beam.

Preferably, the phase corrector unit has a structure formed of a plurality of materials that are successively stacked in the shape of a symmetrical staircase with respect to the optical axis of the laser beam. Those plurality of materials each have an optical path length in the optical axis direction of the laser beam and air which adjoins the materials in the radial direction of the laser beam has an optical path length in the optical axis direction of the laser beam. A difference between respective optical path lengths corresponds to the half-wavelength of the laser beam.

Preferably, those plurality of materials are stacked on a side on which the laser beam is incident as well as on a side from which the laser beam is emitted.

Preferably, the optical pickup device further includes a photodetector detecting light reflected from the optical disk, and a polarization beam splitter allowing the laser beam from the phase corrector unit to pass as it is to direct the laser beam toward the objective lens and reflecting light reflected from the optical disk toward the photodetector.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a structure of an optical pickup device according to the present invention.

FIG. 2 is a plan view with a cross section of a phase corrector unit included in the optical pickup device shown in FIG. 1.

FIG. 3 shows the relative intensity of main and side beams of a laser beam passed through the phase corrector unit.

FIG. 4 shows the intensity of a laser beam which is not passed through the phase corrector unit.

FIG. 5 is a plan view with a cross section of another phase corrector unit included in the optical pickup device shown in FIG. 1.

FIG. 6 is a cross sectional view of still another phase corrector unit included in the optical pickup device shown in FIG. 1.

FIG. 7 is a cross sectional view of a further phase corrector unit included in the optical pickup device shown in FIG. 1.

FIG. 8 is a cross sectional view of a further phase corrector unit included in the optical pickup device shown in FIG. 1.

FIG. 9 is a cross sectional view of a further phase corrector unit included in the optical pickup device shown in FIG. 1.

FIG. 10 is a cross sectional view of a further phase corrector unit included in the optical pickup device shown in FIG. 1.

FIG. 11 is a cross sectional view of a further phase corrector unit included in the optical pickup device shown in FIG. 1.

FIG. 12 is a plan view with a cross section of a further phase corrector unit included in the optical pickup device shown in FIG. 1.

### DESCRIPTION OF THE PREFERRED EMBODIMENTS

One embodiment of the present invention is now described in detail in conjunction with drawings. It is noted that the same or corresponding components are denoted by the same reference character and description thereof is not repeated here.

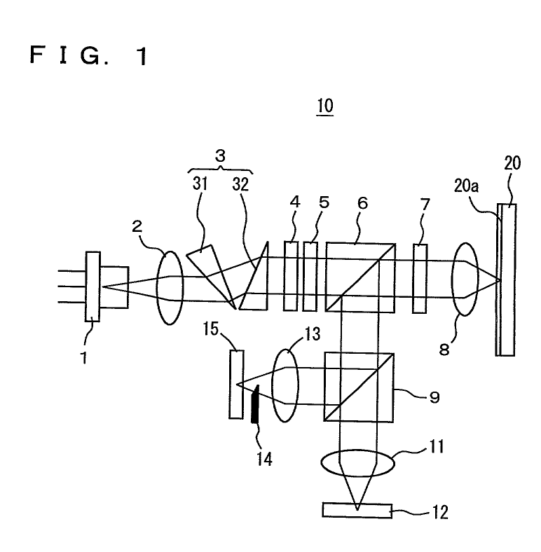

Referring to FIG. 1, an optical pickup device 10 according to the present invention includes a semiconductor laser 1, a collimator lens 2, a beam-shaping prism 3, a diffraction grating 4, a phase corrector unit 5, a polarization beam splitter 6, a quarter-wave plate 7, an objective lens 8, a half mirror 9, condenser lenses 11 and 13, photodetectors 12 and 15, and a knife edge 14. Beam-shaping prism 3 is constituted of prisms 31 and 32.

Semiconductor laser 1 generates a laser beam having a wavelength of 660 nm (tolerance: ±15 nm). Collimator lens 2 produces a beam of parallel light rays from the laser beam emitted from semiconductor laser 1. Beam-shaping prism 3 shapes the laser beam produced as parallel light rays by collimator lens 2. Specifically, the laser beam incident from collimator lens 2 is elliptical in shape, and the elliptical beam shape is formed as close as possible into a circular shape in order to allow the laser beam to sufficiently be focused in both of the major-axis and minor-axis directions of the elliptical beam. Here, prism 31 lengthens the minor axis of the elliptical laser beam incident from collimator lens 2 and prism 32 further lengthens the minor axis of the laser beam incident from prism 31. In this way, beam-shaping prism 3 produces the nearly-circular laser beam.

Diffraction grating 4 produces, by diffraction, 0-order and ±1st-order light, from the laser beam incident from beam-shaping prism 3. Phase corrector unit 5 provides, by a method as described below, a phase difference corresponding to 180° to a plurality of regions arranged in the radial direction of the laser beam. Polarization beam splitter 6 allows the laser beam from phase corrector unit 5 to pass therethrough and turns by 90° the laser beam reflected from a signal recording plane 20a of an optical disk 20. Quarter-wave plate 7 turns by 90° the plane of polarization of the incident laser beam. Objective lens 8 concentrates the laser beam onto signal recording plane 20a of optical disk 20. Half mirror 9 passes a half of the laser beam from polarization beam splitter 6 and turns the remaining half by 90°. Condenser lens 11 concentrates the laser beam passed through half mirror 9 onto photodetector 12. Photodetector 12 detects the laser beam. Photodetector 12 serves to detect a reproduction signal from optical disk 20. Condenser lens 13 concentrates the laser beam reflected from half mirror 9 onto photodetector 15. Knife edge 14 blocks out a part of the laser beam from condenser lens 13. Photodetector 15 detects the laser beam concentrated by condenser lens 13 and partially blocked out by knife edge 14. Photodetector 15 serves to detect a tracking servo signal and a focus servo signal of objective lens 8.

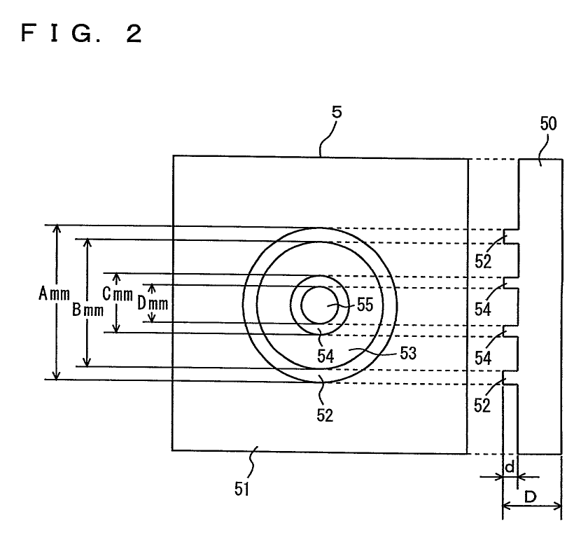

Referring to FIG. 2, phase corrector unit 5 is described in detail. Phase corrector unit 5 includes regions 51-55 on its plane on which the laser beam is incident. Regions 52 and 54 are produced by forming rectangular protrusions on a quartz glass 50. Phase corrector unit 5 is square in shape with the length of one side being 4.200 mm. Regions 52 and 54 are circular. Region 52 has outer diameter A of 1.970 mm and inner diameter B of 1.600 mm. Region 54 has outer diameter C of 0.580 mm and inner diameter D of 0.390 mm. Thus, the width in the direction of the side of region 51 is 0.765 mm, the width of region 52 is 0.185 mm, the width of region 53 is 0.510 mm, the width of region 54 is 0.095 mm, and the width (diameter) D of region 55 is 0.390 mm. Here, the effective diameter of the laser beam incident on phase corrector unit 5 is 3.228 mm and accordingly the laser beam is incident on all of regions 51-55.

If inner diameter B of region 52, outer diameter C of region 54 and inner diameter D of region 54 are fixed respectively at 1.600 mm, 0.580 mm and 0.390 mm, the allowable range of outer diameter A of region 52 is from 1.880 to 2.020 mm. If outer diameter A of region 52, outer diameter C of region 54 and inner diameter D of region 54 are fixed respectively at 1.970 mm, 0.580 mm and 0.390 mm, the allowable range of inner diameter B of region 52 is from 1.480 to 1.660 mm. In addition, if outer diameter A of region 52, inner diameter B of region 52 and inner diameter D of region 54 are fixed respectively at 1.970 mm, 1.600 mm and 0.390 mm, the allowable range of outer diameter C of region 54 is from 0.390 to 0.740 mm. Moreover, if outer diameter A of region 52, inner diameter B of region 52 and outer diameter C of region 54 are fixed respectively at 1.970 mm, 1.600 mm and 0.580 mm, the allowable range of inner diameter D of region 54 is from 0.000 to 0.580 mm.

Respective widths of regions 55, 53 and 51 of phase corrector unit 5 are relatively large, and any width more distant from the center is greater than another width closer to the center. Similarly, regions 54 and 52 have relatively smaller widths and the width more distant from the center is greater than another. Quartz glass 50 has thickness D of 0.5 mm. Height d of regions 52 and 54 is determined to satisfy the following equation:

(n−1) * d=(2m−1) λ/2 (1)

where λ represents the wavelength of the laser beam incident on phase corrector unit 5 and n represents the refractive index of quartz glass 50 (m=1, 2, 3 . . . ). In other words, height d of the protrusions of regions 52 and 54 is determined such that the difference between the optical path length, at phase corrector unit 5, of the laser beam incident on regions 52 and 54 and the optical path length, at phase corrector unit 5, of the laser beam incident on regions 51, 53 and 55 is equal to an odd multiple of the half-wavelength of the laser beam. More specifically, height d is determined such that the phase of the laser beam incident on regions 52 and 54 is delayed by an odd multiple of 180° relative to the phase of the laser beam incident on regions 51, 53 and 55. The refractive index n of quartz glass 50, n=1.4562, wavelength λ of the laser beam, λ=660 nm and m=1 are substituted into equation (1), and then height d is 723.25 nm. The tolerance of height d is ±70 nm.

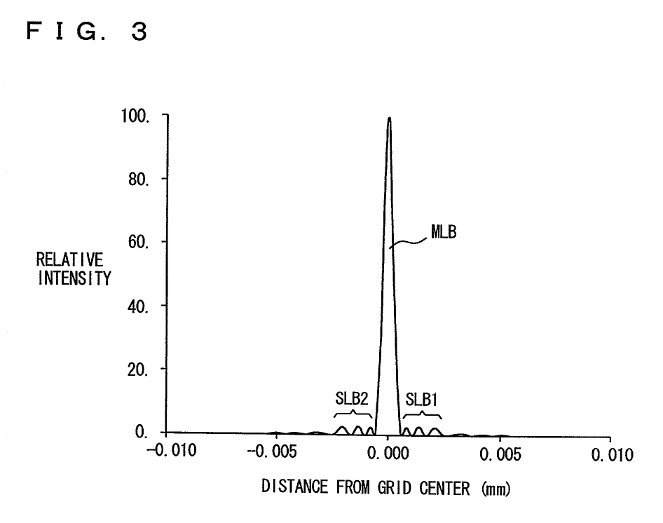

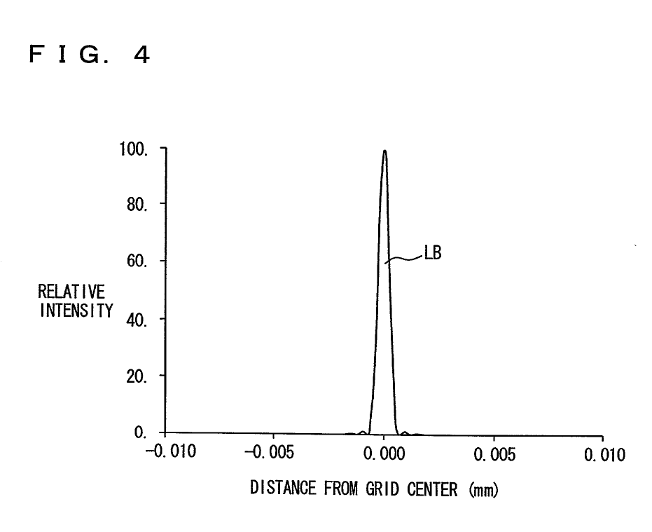

In this way, the laser beam is incident on phase corrector unit 5 and the laser beam incident on regions 52 and 54 is delayed by a phase corresponding to 180° relative to the laser beam incident on regions 51, 53 and 55 (“delayed by a phase corresponding to 180°” means that the phase is delayed by an odd multiple of 180°). Consequently, diffraction is caused by the laser beam passed through regions 52 and 54 of phase corrector unit 5. Thus, the resultant laser beam concentrated by objective lens 8 is constituted of main and side beams as shown in FIG. 3. FIG. 3 shows the relative intensity of main beam MLB and side beams SLB1 and SLB2 when the laser beam passed through phase corrector unit 5 is concentrated by objective lens 8. Referring to FIG. 3, the horizontal axis represents the distance from the center of regions 52 and 54 (grid) of phase corrector unit 5 and the vertical axis represents the relative intensity when the intensity of main beam MLB is 100. Here, the beam diameter of main beam MLB is approximately 0.83 μm, and the intensity of side beams SLB1 and SLB2 is 3% or less relative to the intensity of main beam MLB. FIG. 4 shows the relative intensity of laser beam LB when the laser beam is incident directly on objective lens 8 without being passed through phase corrector unit 5. The beam diameter shown in FIG. 4 is approximately 0.92 μm.

Accordingly, the laser beam is passed through phase corrector unit 5 so as to reduce the beam diameter of the laser beam by approximately 10%, while side beams SLB1 and SLB2 have lower intensity. As the intensity of side beams SLB1 and SLB2 is reduced, the side beams never cause a signal to be recorded on or reproduced from the optical disk and the laser beam can efficiently be used.

Referring back to FIG. 1, an operation of optical pickup device 10 is described. Collimator lens 2 converts a laser beam emitted from semiconductor laser 1 into parallel rays of light. Beam shaping prism 3 forms the shape of the laser beam into a nearly-circular shape, and the resultant laser beam is incident on diffraction grating 4.

The laser beam incident on diffraction grating 4 is diffracted by diffraction grating 4. As discussed above, phase corrector unit 5 gives a phase difference corresponding to the half-wavelength of the laser beam to a part of the laser beam, and the laser beam is then incident on polarization beam splitter 6. The laser beam is passed directly through polarization beam splitter 6 with its polarization plane turned by 90° by quarter-wave plate 7, and incident on objective lens 8. The laser beam incident on objective lens 8 is concentrated by objective lens 8 onto signal recording plane 20a of optical disk 20.

The laser beam reflected from signal recording plane 20a of optical disk 20 passes through objective lens 8 and returns to quarter-wave plate 7. Then, the laser beam is turned by 90° by quarter-wave plate 7 and incident on polarization beam splitter 6. Here, the laser beam incident from quarter-wave plate 7 onto polarization beam splitter 6 has its polarization plane turned by 180° relative to the laser beam incident from phase corrector unit 5 onto polarization beam splitter 6. Therefore, the laser beam is reflected by polarization beam splitter 6 toward half mirror 9. Then, the laser beam reflected from polarization beam splitter 6 has its half transmitted through half mirror 9 and the remaining half reflected toward condenser lens 13.

The laser beam passed through half mirror 9 is concentrated by condenser lens 11 and detected by photodetector 12. A signal is thus reproduced from signal recording plane 20a of optical disk 20. The laser beam reflected from half mirror 9 is concentrated by condenser lens 13, partially blocked out by knife edge 14, and then detected by photodetector 15. Photodetector 15 detects tracking error and focus error signals by so-called knife edge method. The tracking error and focus error signals detected by photodetector 15 are used for tracking servo and focus servo of objective lens 8.

In this way, optical pickup device 10 irradiates signal recording plane 20a of optical disk 20 with the small-diameter laser beam with a high efficiency of use of the laser beam. Accordingly, high-density signal recording on optical disk 20 as well as reproduction of signals from the high-density optical disk are achieved.

The position of phase corrector unit 5 of optical pickup device 10 is not limited to the one between diffraction grating 4 and polarization beam splitter 6. Basically, phase corrector unit 5 located between semiconductor laser 1 and objective lens 8 is acceptable. However, if phase corrector unit 5 is placed between polarization beam splitter 6 and objective lens 8, phase corrector unit 5 provides the above-discussed phase difference twice to the laser beam. More specifically, phase corrector unit 5 once provides this phase difference to the laser beam emitted from semiconductor laser 1 to objective lens 8, and provides again the phase difference to the laser beam which is reflected from signal recording plane 20a of optical disk 20 and incident on polarization beam splitter 6. Since the phase difference corresponding to the half-wavelength of the laser beam is given twice by phase corrector unit 5, side beams SLB1 and SLB2 of the laser beam cannot be distinguished on photodetectors 12 and 15, which could cause noise of a reproduction signal. Then, it is preferable, if optical pickup device 10 is used for reproducing a signal from optical disk 20, to place phase corrector unit 5 between semiconductor laser 1 and polarization beam splitter 6. On the other hand, if optical pickup device 10 is used for recording a signal on optical disk 20, such a problem does not arise. Then, phase corrector unit 5 may be placed at any position between semiconductor laser 1 and objective lens 8.

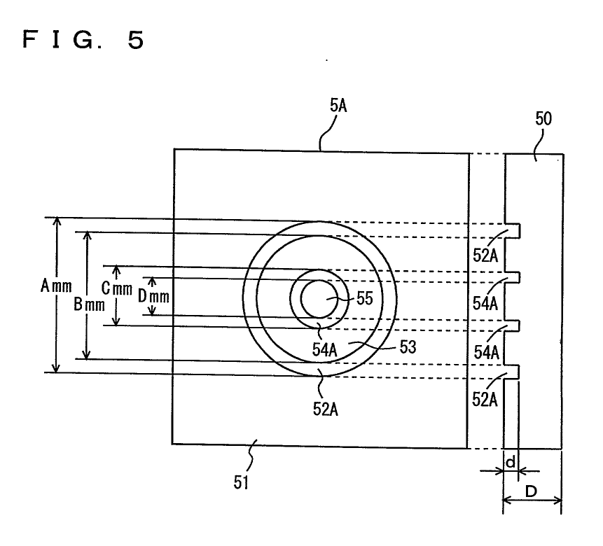

The phase corrector unit for optical pickup device 10 is not limited to the one shown in FIG. 2 and may alternatively be a phase corrector unit 5A shown in FIG. 5. Phase corrector unit 5A includes, on its beam-incident plane, regions 51, 52A, 53, 54A and 55. The outer diameter and inner diameter of region 52A are equal respectively to the outer diameter and inner diameter of region 52 of phase corrector unit 5. In addition, the outer diameter and inner diameter of region 54A are equal respectively to the outer diameter and inner diameter of region 54 of phase corrector unit 5. Then, respective radial widths of regions 51, 52A, 53, 54A and 55 are equal to those of phase corrector unit 5. Regions 52A and 54A are produced as rectangular notches formed in a quartz glass 50. The depth of the notch is equal to height d of the protrusion of phase corrector unit 5. Phase corrector unit 5A can also provide, to a laser beam incident on regions 52A and 54A, a phase difference corresponding to the half-wavelength of the laser beam.

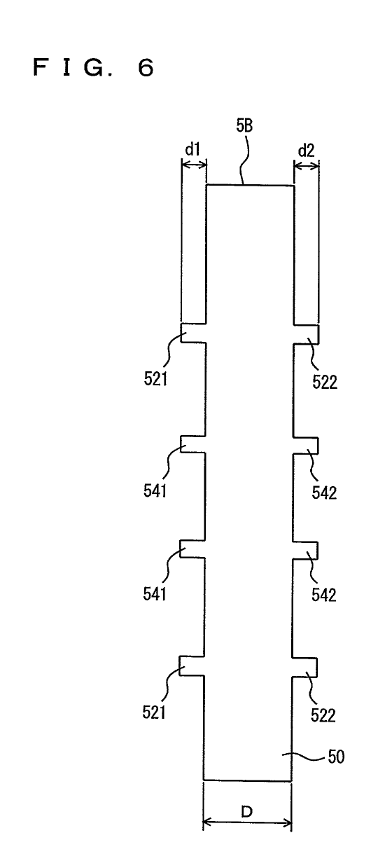

Alternatively, the phase corrector unit for optical pickup device 10 may be a phase corrector unit 5B shown in FIG. 6. Phase corrector unit 5B has respective regions formed of protrusions 521 and 522 and protrusions 541 and 542 corresponding to regions 52 and 54 of phase corrector unit 5. Except for this, phase corrector unit 5B is the same as phase corrector unit 5. The sum of height d1 of protrusions 521 and 541 and height d2 of protrusions 522 and 542 is equal to height d of the protrusions of phase corrector unit 5. In other words, heights d1 and d2 are determined to satisfy the relation d1+d2=d.

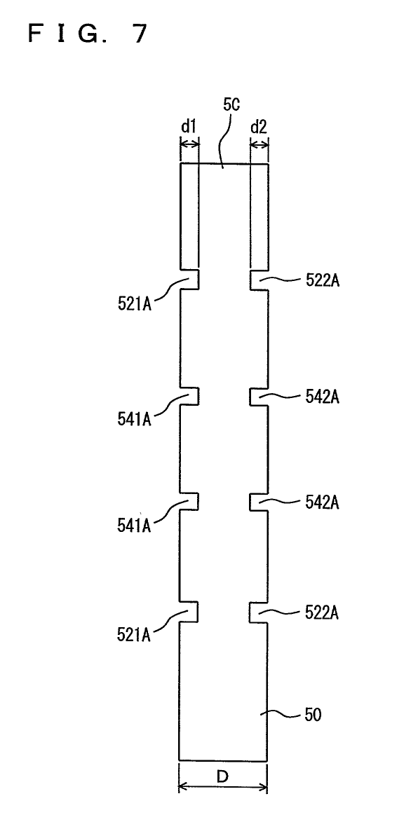

Alternatively, the phase corrector unit for optical pickup device 10 may be a phase corrector unit 5C shown in FIG. 7. Phase corrector unit 5C has respective regions formed of protrusions 521A and 522A and protrusions 541A and 542A corresponding to regions 52 and 54 of phase corrector unit 5. Except for this, phase corrector unit 5C is the same as phase corrector unit 5. The sum of height d1 of protrusions 521A and 541A and height d2 of protrusions 522A and 542A is equal to height d of the protrusions of phase corrector unit 5. In other words, heights d1 and d2 are determined to satisfy the relation d1+d2=d.

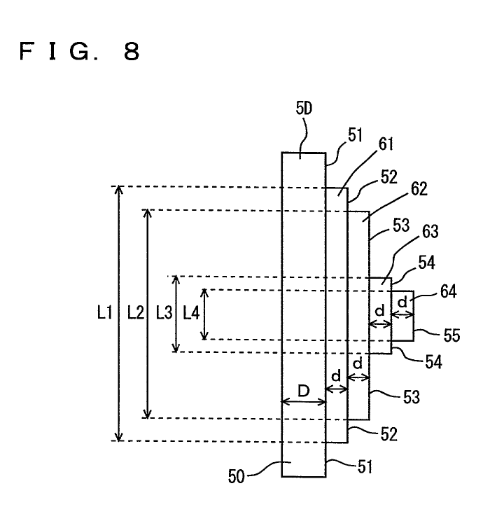

Alternatively, a phase corrector unit 5D shown in FIG. 8 may be used for optical pickup device 10. Phase corrector unit 5D has a structure constituted of quartz elements 61-64 stacked on a quartz element 50. Quartz element 61 has diameter L1 equal to outer diameter A of region 52 of phase corrector unit 5 and quartz element 62 has diameter L2 equal to inner diameter B of region 52 of phase corrector unit 5. Moreover, quartz element 63 has diameter L3 equal to outer diameter C of region 54 of phase corrector unit 5 and quartz element 64 has diameter L4 equal to inner diameter D of region 54 of phase corrector unit 5. In other words, phase corrector unit 5D has the structure formed of quartz elements 61-64 that are stacked on quartz element 50, circular in shape and have different diameters respectively. Then, phase corrector unit 5D has regions 51-55 similarly to phase corrector unit 5. Quartz element 50 has thickness D and quartz elements 61-64 each have thickness d. Except for this, phase corrector unit 5D is the same as phase corrector unit 5.

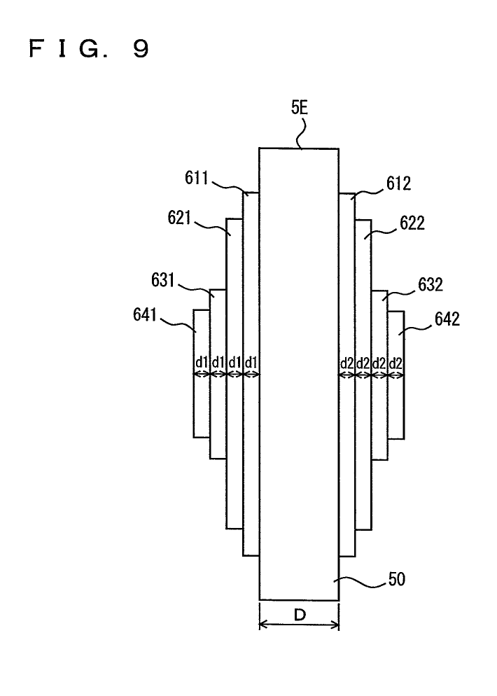

Alternatively, the phase corrector unit for optical pickup device 10 may be a phase corrector unit 5E shown in FIG. 9. Phase corrector unit 5E has a structure constituted of quartz elements 611, 621, 631 and 641 successively stacked on one side of a quartz element 50 and quartz elements 612, 622, 632 and 642 successively stacked on the other side of quartz element 50. The diameter of quartz elements 611 and 612 is equal to diameter L1 of quartz element 61 of phase corrector unit 5D, the diameter of quartz elements 621 and 622 is equal to diameter L2 of quartz element 62 of phase corrector unit 5D, the diameter of quartz elements 631 and 632 is equal to diameter L3 of quartz element 63 of phase corrector unit 5D, and the diameter of quartz elements 641 and 642 is equal to diameter L4 of quartz element 64 of phase corrector unit 5D. Further, the sum of thickness d1 of quartz elements 611, 621, 631 and 641 and thickness d2 of quartz elements 612, 622, 632 and 642 is equal to thickness d of quartz elements 61-64 of phase corrector unit 5D. In other words, thicknesses d1 and d2 are determined to satisfy the relation d1+d2=d. Except for this, phase corrector unit 5E is the same as phase corrector unit 5.

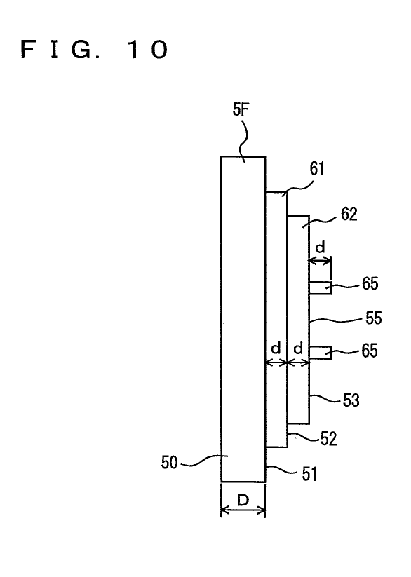

Alternatively, a phase corrector unit 5F shown in FIG. 10 may be used for optical pickup device 10. Phase corrector unit 5F has a structure constituted of quartz elements 61, 62 and 65 stacked successively on a quartz element 50. Quartz element 65 is ring-shaped having its outer diameter equal to outer diameter C of region 54 of phase corrector unit 5 and its inner diameter equal to inner diameter D of region 54 of phase corrector unit 5. Quartz element 65 has its thickness d equal to thickness d of quartz elements 61 and 62. Phase corrector unit 5F with its structure as shown in FIG. 10 also has regions 51-55. Except for this, phase corrector unit 5F is the same as phase corrector unit 5.

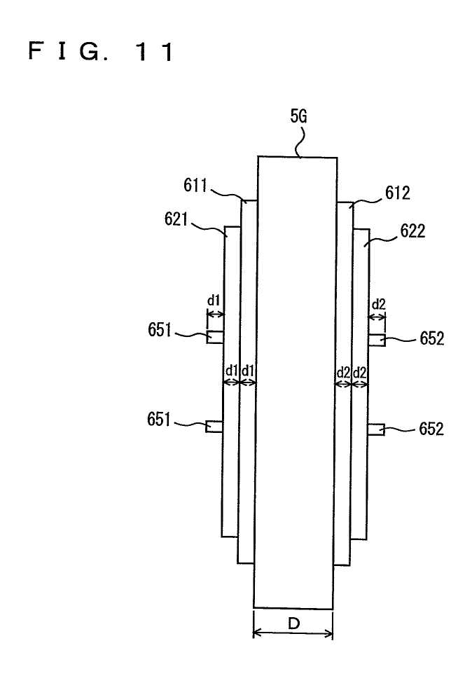

Alternatively, the phase corrector unit for optical pickup device 10 may be a phase corrector unit 5G shown in FIG. 11. Phase corrector unit 5G has a structure constituted of quartz elements 611, 621 and 651 stacked successively on one side of a quartz element 50 and quartz elements 612, 622 and 652 stacked successively on the other side of quartz element 50. Quartz elements 651 and 652 are ring-shaped having the outer diameter equal to outer diameter C of region 54 of phase corrector unit 5 and the inner diameter equal to inner diameter D of region 54 of phase corrector unit 5. The sum of thickness d1 of quartz elements 611, 621 and 651 and thickness d2 of quartz elements 612, 622 and 652 is equal to thickness d of quartz elements 61, 62 and 65 of phase corrector unit 5F. In other words, thicknesses d1 and d2 are determined to satisfy the relation d1+d2=d. Except for this, phase corrector unit 5G is the same as phase corrector unit 5F.

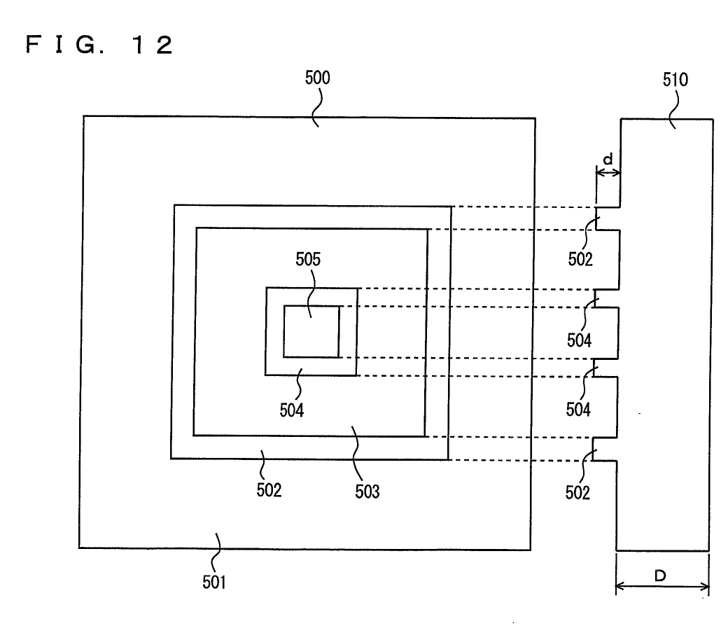

According to the description above, to the laser beam incident on circular regions 52 and 54, a phase difference corresponding to the half-wavelength of the laser beam is given. However, these regions may be rectangular as shown in FIG. 12 according to the present invention. Specifically, a phase corrector unit 500 has regions 501-505 on its plane on which a laser beam is incident. Regions 502 and 504 are produced by forming rectangular protrusions on a quartz glass 510. Phase corrector unit 500 is square in shape with the length of one side being 4.200 mm. Regions 502 and 504 are also square in shape. The length of one side of the outer boundary of region 502 is equal to outer diameter A of region 52 of phase corrector unit 5, and the length of one side of the inner boundary thereof is equal to inner diameter B of region 52 of phase corrector unit 5. The length of one side of the outer boundary of region 504 is equal to outer diameter C of region 54 of phase corrector unit 5, and the length of one side of the inner boundary thereof is equal to inner diameter D of region 54 of phase corrector unit 5. The effective diameter of the laser beam incident on phase corrector unit 500 is 3.228 mm and thus the laser beam is incident on all of regions 501-505.

Thickness D of quartz 510 and height d of the protrusions of regions 502 and 504 are the same as those of phase corrector unit 5. Phase corrector unit 500 is similar to phase corrector unit 5 except for the difference described above. Moreover, any modifications as shown in FIGS. 5-11 can be made to phase corrector unit 500.

One characteristic of the present invention is that an optical disk is irradiated with a laser beam constituted of main and side beams that are generated by providing a phase difference to a laser beam incident on a plurality of regions, the phase difference being corresponding to the half-wavelength of the laser beam. The intensity of the side beams is changed by varying respective widths of a plurality of regions of above-discussed phase corrector units 5, 5A, 5B, 5C, 5D, SE, 5F, 5G and 500. If an optical disk has its signal-recording-plane formed of a phase change film, a side beam having its intensity which exceeds 5% of the intensity of the main beam could not allow a signal to be recorded on the plane. Then, according to the present invention, the intensity of the side beam is determined so that a signal is not recorded by this side beam.

Moreover, according to the description above, the wavelength of the laser beam emitted from semiconductor laser 1 is 660 nm. However, the wavelength of the laser beam may range from 400 to 500 nm and generally, the wavelength may range from 400 to 700 nm.

According to this embodiment, the optical pickup device includes the phase corrector unit providing, to a laser beam incident on a plurality of regions, a phase difference corresponding to the half-wavelength of the laser beam. In this way, the laser beam having a small beam diameter is emitted onto a signal-recording-plane of an optical disk while a high efficiency of use of the laser beam is maintained. High-density signal recording as well as high-density signal reproduction are thus achieved.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An optical pickup device comprising:
a laser source generating a laser beam;
a phase corrector unit having a plurality of regions arranged in the radial direction of said laser beam for providing a phase difference corresponding to the half-wavelength of said laser beam to the laser beam incident on two adjacent regions of said plurality of regions; and
an objective lens concentrating said laser beam from said phase corrector unit onto an optical disk, wherein
said plurality of regions have respective lengths in said radial direction that are different from each other.

2. The optical pickup device according to claim 1, wherein
one of said two adjacent regions has a first optical path length in the optical axis direction of said laser beam,
the other of said two adjacent regions has a second optical path length in the optical axis direction of said laser beam and
a difference between said first optical path length and said second optical path length corresponds to the half-wavelength of said laser beam.

3. The optical pickup device according to claim 2, wherein
said phase corrector unit is formed of
a first material and
second materials formed on a main surface of said first material with a predetermined distance therebetween,
air adjoining said second materials in the radial direction of said laser beam has an optical path length in the optical axis direction of said laser beam and said second materials have an optical path length in the optical axis direction of said laser beam, and
a difference between respective optical path lengths corresponds to the half-wavelength of said laser beam.

4. The optical pickup device according to claim 2, wherein
said phase corrector unit is formed of a material having rectangular notches formed at a main surface with a predetermined distance therebetween,
said material has a part which adjoins said rectangular notches in the radial direction of said laser beam and said part has an optical path length in the optical axis direction of said laser beam and, said rectangular notches have an optical path length in the optical axis direction of said laser beam and
a difference between respective optical path lengths corresponds to the half-wavelength of said laser beam.

5. The optical pickup device according to claim 2, wherein
said phase corrector unit is formed of a material having rectangular notches with a predetermined distance therebetween, said notches formed on a side on which said laser beam is incident as well as on a side from which said laser beam is emitted,
said material has a part which adjoins said rectangular notches in the radial direction of said laser beam and said part has an optical path length in the optical axis direction of said laser beam and, said rectangular notches have an optical path length in the optical axis direction of said laser beam and
a difference between respective optical path lengths corresponds to the half-wavelength of said laser beam.

6. The optical pickup device according to claim 2, wherein
said phase corrector unit has a structure formed of a plurality of materials that are successively stacked in the shape of a symmetrical staircase with respect to the optical axis of said laser beam,
said plurality of materials each have an optical path length in the optical axis direction of said laser beam and air which adjoins said materials in the radial direction of said laser beam has an optical path length in the optical axis direction of said laser beam and
a difference between respective optical path lengths corresponds to the half-wavelength of said laser beam.

7. The optical pickup device according to claim 6, wherein
said plurality of materials are stacked on a side on which said laser beam is incident as well as on a side from which said laser beam is emitted.

8. The optical pickup device according to claim 1, further comprising:
a photodetector detecting light reflected from said optical disk; and
a polarization beam splitter allowing the laser beam from said phase corrector unit to pass as it is to direct the laser beam toward said objective lens and reflecting light reflected from said optical disk toward said photodetector.
